(19) United States
(12) Patent Application Publication
(10) Pub. No.: US 2009/0025581 A1
(43) Pub. Date: Jan. 29, 2009

(54) Mask for screen printing and screen printing method using the same

(75) Inventors: Soon Jin Cho, Gyunggi-do (KR); Seon Jae Mun, Busan (KR); Jin Won Choi, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/003,491

(22) Filed: Dec. 26, 2007

(30) Foreign Application Priority Data
Jul. 27, 2007 (KR) 10-2007-0075740

(51) Int. Cl. B05C 17/06; B41M 1/12

(52) U.S. Cl. 101/127; 101/129

(57) ABSTRACT

This invention relates to a mask for screen printing, which includes a mask body composed of a plurality of pattern areas having holes for screen printing and a peripheral area surrounding the outside of the pattern areas; and a protrusion portion formed in the peripheral area of a back surface of the mask body, and to a screen printing method using the same.

### CROSS REFERENCE TO RELATED APPLICATION

This application claims the benefit of Korean Patent Application No. 10-2007-0075740, filed on Jul. 27, 2007, entitled “Mask for screen printing and method for screen printing using the same”, which is hereby incorporated by reference in its entirety into this application.

### BACKGROUND OF THE INVENTION

1. Field of the Invention

The present invention relates, in general, to a mask for screen printing and a screen printing method using the same. More particularly, the present invention relates to a mask for screen printing, which includes a protrusion portion in the peripheral area of a back surface of the mask body thereof, thereby realizing an effect of greatly improved plate separation, and to a screen printing method using the same.

2. Description of the Related Art

In the case where a printing agent, such as a solder paste, is printed using a screen mask, it is very important to attain uniform printing quality. Factors affecting the printing quality include a printing agent, such as a solder paste, a screen mask, and a printer. Among these factors, the structure of a screen mask that is able to improve printing quality is described below.

In the printing process, the holes in a screen mask are filled with a printing agent using a metal or urethane squeegee, after which the screen mask is separated from a substrate (a printed circuit board (PCB), a semiconductor wafer, etc.). This is called plate separation, and the printing quality varies greatly depending on the conditions for plate separation.

For example, screen printing technology is useful as a method of forming solder bumps on a circuit substrate, such as a PCB or a semiconductor wafer. Such screen printing technology is briefly described below, with reference to FIGS. 5A to 5D.

Screen printing technology includes disposing a screen mask 502 having holes corresponding to a predetermined pattern on a substrate 501 on which a solder paste 503 is to be applied (FIG. 5A), printing the solder paste 503 on the screen mask 502 using a squeegee 504 to fill the holes in the screen mask 502 with the solder paste (FIG. 5B), separating the screen mask 502 from the substrate 501 (FIG. 5C), and subjecting the solder paste 503, applied on the substrate 501, to melt curing through reflow, thus forming micro solder balls 504 (FIG. 5D).

The screen printing technology is variously used because it is suitable for mass production and has a relatively simple process, but has the following problems.

As illustrated in FIGS. 6A to 6E, when a screen mask 603 is separated from a substrate 602 located on a printing table 601, the separation of the screen mask 603 from the surface of the substrate 602 progresses from the peripheral area of the screen mask 603 toward the central portion of the screen mask 603. Thus, the solder paste, which is provided on the surface of the substrate 602, is deformed due to the difference in the separating time between the central portion and the peripheral area of the surface of the substrate 602. In this way, for plate separation, because the time and conditions for plate separation vary at different positions of the substrate, it is difficult to realize uniform printing quality at different positions on the substrate.

That is, the solder paste provided on the substrate is subjected to different amounts of stress at the peripheral area and the central portion of the substrate, and consequently the applied (charged) solder paste is deformed by the screen mask, making it impossible to transfer all of the solder paste from the screen mask to the substrate. This phenomenon, in which the solder paste is attached to the screen mask and is thus not transferred, occurs depending on the position of the screen mask and the shape of the pattern, undesirably causing variation in printing of a final product. This problem increases in severity as the size of the substrate increases, the patterned portion of the screen mask is thinner, and the intervals between the holes in the screen mask decrease.

In addition, variation in the volume of the solder paste that is printed may be caused as follows. When the area that is printed once with the paste is large, during the process, between the printing of the paste and the separation of the screen mask, the substrate and the screen mask are in a state of being bonded to each other by the visco-elastic solder paste. In this state, in order to separate the screen mask, external air must flow in. The case where the area printed with the solder paste is large makes it difficult to realize the inflow of external air. Thus, when the screen mask is separated by force, the screen mask and the substrate are maintained in an instant vacuum state. At this point, in order to separate the mask from the substrate, the force of a critical load or more must be applied between the screen mask and the substrate. In this case, because the separation speed is very high, high shear stress occurs between the holes in the screen mask and the paste, as seen in FIG. 7, undesirably causing the solder paste to remain on the wall surface of the hole of the screen mask.

With the goal of solving the above problem, attempts to control a printer so as to repeat a predetermined acceleration/deceleration pattern upon plate separation have been made. However, this method is disadvantageous because a complicated means for applying the acceleration/deceleration pattern must be designed and provided to the printer. Such additional means must precisely operate a transfer means depending on the acceleration/deceleration pattern and therefore the construction thereof is complicated and high costs are incurred.

### SUMMARY OF THE INVENTION

Leading to the present invention, intensive and thorough research, aiming to solve the problems encountered in the related art, resulted in the finding that a protrusion portion may be additionally formed in the peripheral area of a screen mask, thus making it possible to solve the problem of low quality occurring upon plate separation between the substrate and the screen mask.

Accordingly, the present invention provides a mask for screen printing, which can improve final printing quality under uniform conditions for plate separation regardless of the position of the substrate, and also a screen printing method using the same.

According to the present invention, a mask for screen printing may include (a) a mask body, including a plurality of pattern areas having holes for screen printing and a peripheral area surrounding an outside of the pattern areas; and (b) a protrusion portion, formed in the peripheral area of a back surface of the mask body.

In the mask for screen printing, the protrusion portion may have a structure in a form of a plurality of strips or a lattice or a cube or a pillar.

The mask body and the protrusion portion may be formed of the same material or different materials.

According to a first embodiment, the protrusion portion may be formed of a polymer or a filler-containing polymer.

According to a second embodiment, the protrusion portion may be formed of a single metal or a metal alloy. Preferably, the single metal or the metal alloy is selected from the group consisting of Fe, Ni, Cr, Cu, Co, Zn, Pb, Sn, and alloys thereof.

The mask for screen printing may be integrally formed through a series of continuous processes.

In addition, according to the present invention, a screen printing method may include (a) preparing a circuit substrate; (b) preparing a mask for screen printing, including (i) a mask body, including a plurality of pattern areas having holes for screen printing and a peripheral area surrounding an outside of the pattern areas, and (ii) a protrusion portion formed in the peripheral area of a back surface of the mask body; (c) disposing the mask for screen printing on the circuit substrate so that the protrusion portion of the mask for screen printing is brought into contact with the circuit substrate, and printing a printing agent on the circuit substrate using a squeegee; and (d) separating the mask for screen printing from the circuit substrate.

### BRIEF DESCRIPTION OF THE DRAWINGS

FIG. 1 is a top plan view illustrating the mask for screen printing according to the present invention;

FIG. 2 is a sectional view taken along the line A-A′ of FIG. 1, illustrating the mask for screen printing;

FIGS. 3A to 3H are views schematically illustrating the process of manufacturing a mask for screen printing according to a first embodiment of the present invention;

FIGS. 4A to 4H are views schematically illustrating the process of manufacturing a mask for screen printing according to a second embodiment of the present invention;

FIGS. 5A to 5D are views schematically illustrating the process of forming solder bumps according to a conventional technique;

FIGS. 6A to 6E are views schematically illustrating the deformation of the mask upon plate separation in the course of screen printing; and

FIG. 7 is a view illustrating the generation of shear stress between the mask and the solder paste upon plate separation in the course of screen printing.

### DESCRIPTION OF THE PREFERRED EMBODIMENTS

Hereinafter, a detailed description will be given of the present invention, with reference to the appended drawings.

In the present invention, there is provided a novel screen mask having a structure which provides uniform conditions for plate separation regardless of the position of the substrate and does not cause the deformation of a solder paste due to shear stress upon plate separation.

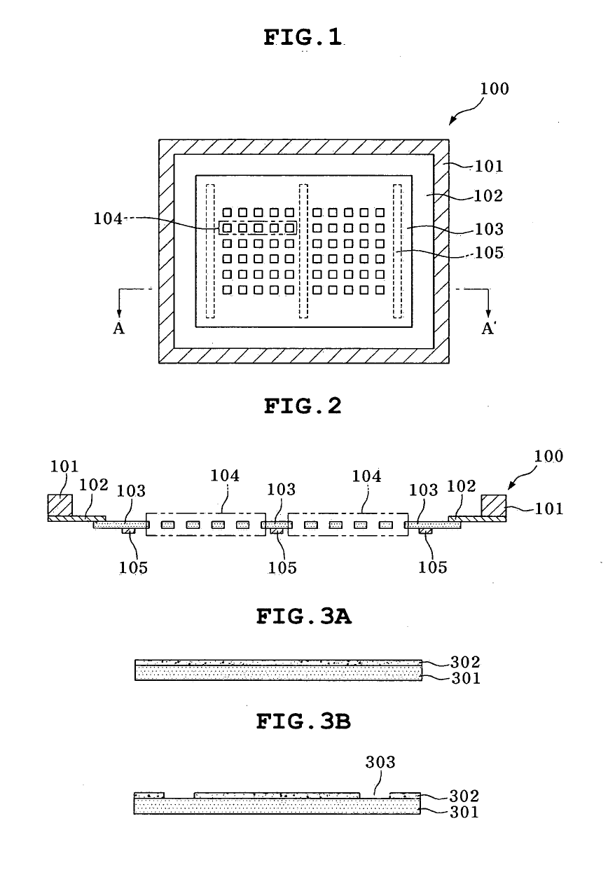

FIG. 1 is a top plan view illustrating the mask for screen printing according to the present invention, and FIG. 2 is a sectional view taken along the line A-A′ of FIG. 1.

With reference to FIGS. 1 and 2, a mask 100 for screen printing according to the present invention includes a mask body composed of a plurality of pattern areas 104 having holes for screen printing and a peripheral area 103 surrounding the outside thereof, and protrusion portions 105 formed in the peripheral area 103 of a back surface of the mask body.

The mask 100 for screen printing is securely held to a holder 101, such as a metal frame, through a holding portion 102, such as a mesh, thus facilitating printing.

More particularly, the mask body of the mask 100 for screen printing includes the peripheral area 103, having no pattern, and the pattern areas 104, having patterns. The pattern areas 104 have predetermined patterns, which are periodically repeated.

The mask body of the mask for screen printing is typically formed of a single metal or a metal alloy, or alternatively a polymer or a polymer containing a reinforcing filler such as glass fiber. The present invention is not limited thereto, rather, any material may be used for the mask body so long as it is known in the art. Typically, the peripheral area and the pattern area of the mask body of the mask for screen printing have the same thickness and are formed of the same material.

In the peripheral area 103 of a back surface of the mask body, the protrusion portions 105 are formed. The protrusion portions 105 may be formed of a material which is the same as or different from the material for the mask body, specifically, the pattern area 104 and/or the peripheral area 103 of the mask body.

Preferably, the protrusion portions 105 are formed of a polymer, or a polymer containing a filler such as a glass fiber or a ceramic filler, or alternatively, a single metal or a metal alloy. The single metal or the metal alloy is not particularly limited, but any one or an alloy of two or more thereof selected from among Fe, Ni, Cr, Cu, Co, Zn, Pb, and Sn may be used.

The protrusion portions 105 may be provided in the form of a plurality of strips or a lattice or a cube or a pillar in the peripheral area 103 positioned between the pattern areas 104 and in the peripheral area 103 positioned surrounding the entire pattern areas 104.

Preferably, the mask for screen printing may be integrally formed through a series of continuous processes. In this way, in the case where the mask is integrally formed, the protrusion portions are held to the mask body, and thus no additional jig is needed. Further, design freedom is high.

The method of manufacturing the mask for screen printing is described in detail below, but the present invention is not limited thereto, and any method known in the art may be applied.

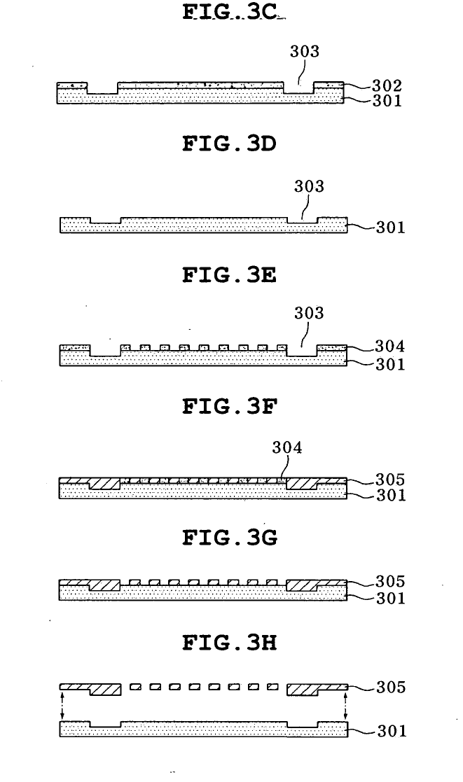

With reference to FIGS. 3A to 3H, the method of manufacturing the mask according to a first embodiment of the present invention is described.

On a base plate 301 for use in the preparation of a metal mask through electroforming, a first photosensitive material 302 is applied (FIG. 3A), typically exposed/developed (FIG. 3B), etched (FIG. 3C), and then striped (FIG. 3D), thus forming trenches 303 corresponding to the protrusion portions. In the drawing, only two trenches 303 for the protrusion portions are formed at opposite outer sides of the base plate, but additional trenches for the protrusion portions may be formed at different positions in the central portion thereof, if necessary, which will be readily apparent and easily understood by those skilled in the art.

Subsequently, a second photosensitive material 304 is applied and then patterned through typical exposure and development, thus removing the portion of the second photosensitive material 304 other than the portion of the second photosensitive material corresponding to the hole (FIG. 3E). The photosensitive material includes, for example, a liquid photoresist or a photoresist such as a dry film, and any material may be used, so long as it is known in the art.

Next, the base plate 301, on which the second photosensitive material 304 is applied, is subjected to fill plating through typical metal electroplating, thus forming a plating layer 305 (FIG. 3F), after which the second photosensitive material 304 is stripped (FIG. 3G). The mask thus manufactured is separated from the base plate 301, thereby simultaneously forming the protrusion portions, the pattern area and the peripheral area of the mask for screen printing (FIG. 3H).

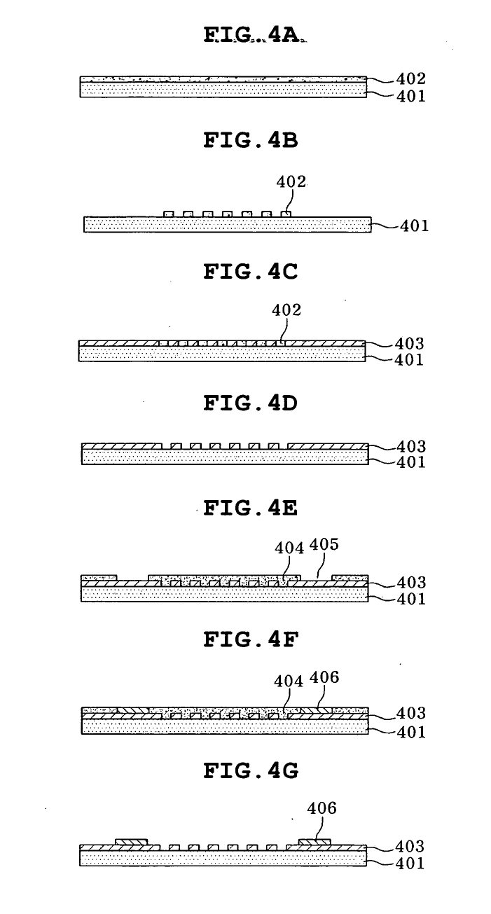

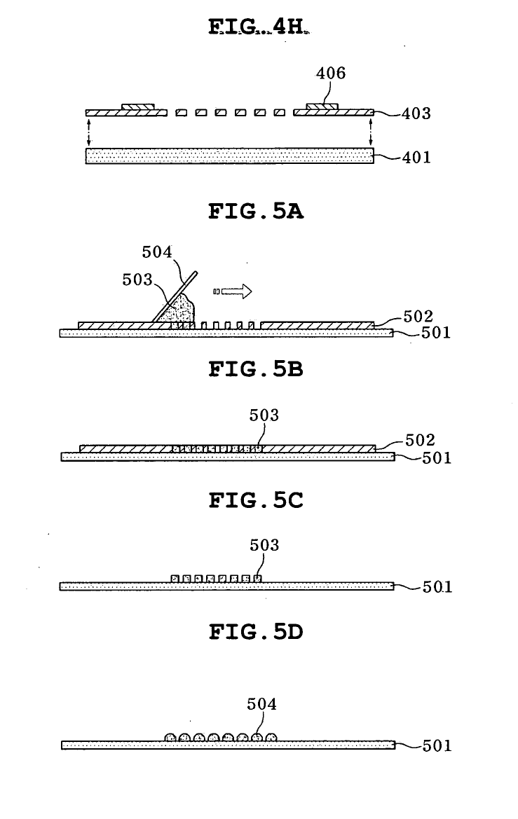

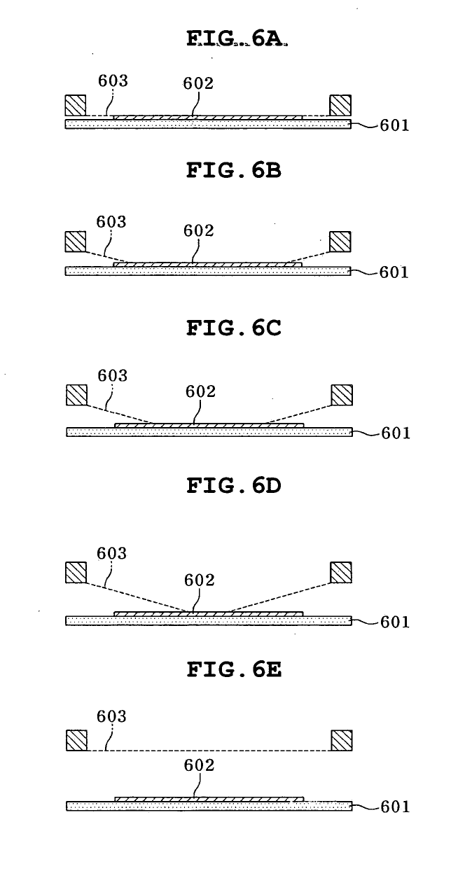

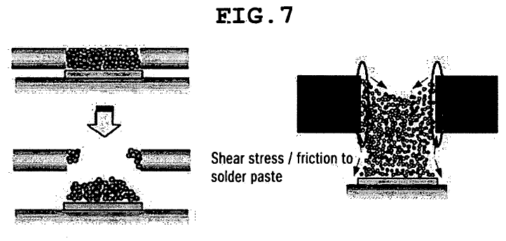

With reference to FIGS. 4A to 4H, the method of manufacturing the mask according to a second embodiment of the present invention is described below.

On a base plate 401 for use in the preparation of a metal mask through electroforming, a first photosensitive material 402 is applied (FIG. 4A), and is then patterned through typical exposure and development, thus removing the portion of the first photosensitive material 402 other than the portion of the first photosensitive material corresponding to the hole (FIG. 4B).

Subsequently, the base plate 401, on which the first photosensitive material 402 is applied, is subjected to fill plating through typical metal electroplating, thus forming a plating layer 403 (FIG. 4C), after which the first photosensitive material 402 is stripped, thus simultaneously forming the peripheral area and the pattern area of the mask for screen printing (FIG. 4D).

Next, a second photosensitive material 404 is applied and then patterned through typical exposure and development, thus removing the portion of the second photosensitive material 404 corresponding to the protrusion portions, thus forming trenches 405 (FIG. 4E). Through typical metal electroplating, a plating layer 406 is formed in the trenches for the protrusion portions (FIG. 4F). Unlike the first embodiment, in the second embodiment, the protrusion portions may be formed of material different from that for the pattern area/peripheral area.

Subsequently, the second photosensitive material 404 is removed (FIG. 4G), and the mask thus manufactured is separated from the base plate 401 (FIG. 4H).

The mask for screen printing is disposed on a circuit substrate, such as a PCB or a semiconductor wafer, on which a printing agent is to be applied, so that the protrusion portions of the mask are brought into contact with the circuit substrate, after which the printing agent is printed using a squeegee and then the mask is separated, thereby realizing screen printing.

For example, in the case where solder balls are formed on a solder pad, exposed through the solder resist open portion formed in the outermost layer of the substrate, screen printing may be performed as follows, but the present invention is not limited thereto.

Specifically, on the substrate on which the solder pad is exposed in the outermost layer thereof, the mask for screen printing is disposed so that the protrusion portions of the mask for screen printing, having holes corresponding to the solder pad, are brought into contact with the substrate, after which the solder paste, serving as a printing agent, is printed on the mask using a squeegee to thus fill the holes in the mask with the solder paste. Subsequently, the mask for screen printing is separated from the substrate, after which the solder paste, applied on the substrate, is subjected to melt curing through typical reflow, thus forming micro solder balls.

As mentioned above, the mask for screen printing according to the present invention has protrusion portions which are formed in the periphery (i.e., in the peripheral area) of the pattern areas thereof. Thereby, when the mask for screen printing is separated from the substrate, uniform conditions for plate separation may be formed at all positions of the substrate. Further, the deformation of the printing agent by stress occurring upon plate separation may be minimized, thus improving printing quality. When a large-size substrate, such as a PCB, is subjected to screen printing, the application of the mask for screen printing according to the present invention can improve plate separation to thus increase printing uniformity. Moreover, the mask for screen printing according to the present invention may be applied to any printer without requiring any change of equipment.

Although the preferred embodiments of the present invention with regard to the mask for screen printing and the screen printing method using the same have been disclosed for illustrative purposes, those skilled in the art will appreciate that various modifications, additions and substitutions are possible within the technical spirit of the invention.

As described hereinbefore, the present invention provides a mask for screen printing and a screen printing method using the same. According to the present invention, the mask for screen printing has protrusion portions, which are formed in the peripheral area of a back surface of the mask body thereof, thereby improving printing uniformity upon screen printing and preventing the deformation of a solder resist due to shear stress upon plate separation, and furthermore, may be applied to any printer without requiring any change of equipment.

Simple modifications, additions and substitutions fall within the scope of the present invention as defined in the accompanying claims.

What is claimed is:

1. A mask for screen printing, comprising:
(a) a mask body, including a plurality of pattern areas having holes for screen printing and a peripheral area surrounding an outside of the pattern areas; and
(b) a protrusion portion, formed in the peripheral area of a back surface of the mask body.

2. The mask for screen printing as set forth in claim 1, wherein the protrusion portion has a structure in a form of a plurality of strips or a lattice or a cube or a pillar.

3. The mask for screen printing as set forth in claim 1, wherein the mask body and the protrusion portion comprise the same material.

4. The mask for screen printing as set forth in claim 1, wherein the mask body and the protrusion portion comprise different materials.

5. The mask for screen printing as set forth in claim 1, wherein the protrusion portion comprises a polymer or a filler-containing polymer.

6. The mask for screen printing as set forth in claim 1, wherein the protrusion portion comprises a single metal or a metal alloy.

7. The mask for screen printing as set forth in claim 6, wherein the single metal or the metal alloy is selected from a group consisting of Fe, Ni, Cr, Cu, Co, Zn, Pb, Sn, and alloys thereof.

8. The mask for screen printing as set forth in claim 1, which is integrally formed through a series of continuous processes.

9. A screen printing method, comprising:
(a) preparing a circuit substrate;
(b) preparing a mask for screen printing, comprising (i) a mask body, including a plurality of pattern areas having holes for screen printing and a peripheral area surrounding an outside of the pattern areas, and (ii) a protrusion portion formed in the peripheral area of a back surface of the mask body;
(c) disposing the mask for screen printing on the circuit substrate so that the protrusion portion of the mask for screen printing is brought into contact with the circuit substrate, and printing a printing agent on the circuit substrate using a squeegee; and
(d) separating the mask for screen printing from the circuit substrate.

10. The method as set forth in claim 9, wherein the protrusion portion has a structure in a form of a plurality of strips or a lattice or a cube or a pillar.

11. The method as set forth in claim 9, wherein the mask body and the protrusion portion comprise the same material.

12. The method as set forth in claim 9, wherein the mask body and the protrusion portion comprise different materials.

13. The method as set forth in claim 9, wherein the protrusion portion comprises a polymer or a filler-containing polymer.

14. The method as set forth in claim 9, wherein the protrusion portion comprises a single metal or a metal alloy.

15. The method as set forth in claim 14, wherein the single metal or the metal alloy is selected from a group consisting of Fe, Ni, Cr, Cu, Co, Zn, Pb, Sn, and alloys thereof.

16. The method as set forth in claim 9, wherein the mask for screen printing is integrally formed through a series of continuous processes.
